(19) United States
(12) Patent Application Publication
(10) Pub. No.: US 2013/0132100 A1
(43) Pub. Date: May 23, 2013

(54) APPARATUS AND METHOD FOR CODEC SIGNAL IN A COMMUNICATION SYSTEM

(71) Applicant: Electronics and Telecommunications Research, Daejeon (KR)

(72) Inventors: Jong-Mo SUNG, Daejeon (KR); Do-Young KIM, Daejeon (KR); Byung-Sun LEE, Daejeon (KR)

(73) Assignee: Electronics and Telecommunications Research Institute, Daejeon (KR)

(21) Appl. No.: 13/662,766

(22) Filed: Oct. 29, 2012

(30) Foreign Application Priority Data
Oct. 28, 2011 (KR) 10-2011-0111486

(51) Int. Cl. G10L 19/02; G10L 19/032

(52) U.S. Cl. CPC G10L 19/0208; G10L 19/032
USPC 704/501

(57) ABSTRACT

The present invention relates to a codec apparatus and method for coding/decoding speech and audio signals in a communication system. In accordance with the present invention, a speech and audio signal in a time domain is transformed into a speech and audio signal in a frequency domain and calculating frequency coefficients of the speech and audio signal, the frequency coefficients are split by a plurality of sub-bands and the sub-band coefficients of the respective sub-bands are calculated from the frequency coefficients, and the sub-band coefficients are quantized depending on a characteristic of the plurality of sub-bands and sub-band quantization indices are calculated by quantizing the sub-band coefficients.

### CROSS-REFERENCE TO RELATED APPLICATION

The present application claims priority of Korean Patent Application No. 10-2011-0111486, filed on Oct. 28, 2011, which is incorporated herein by reference in its entirety.

### BACKGROUND OF THE INVENTION

1. Field of the Invention

Exemplary embodiments of the present invention relate to a communication system and, more particularly, to a codec apparatus and method for coding voice and audio signals in a communication system.

2. Description of the Related Art

In a communication system, active research are being carried out in order to provide users with various types of Quality of Services (hereinafter referred to as ‘QoSs’) having a high transfer rate. In this communication system, schemes for transmitting data having various types of QoSs through limited resources rapidly are being proposed. With the recent development of networks and the recent increase of user demands for high quality service, schemes for compressing and restoring speech and audio signals in order to transmit and receive the speech and audio signals over a network have been proposed.

Meanwhile, in order to transmit and receive speech and audio signals over a digital communication network, an encoder for compressing the speech and audio signals converted into digital signals and a decoder for restoring the speech and audio signals from the compressed signals are essential to a communication system. In general, the encoder and the decoder are collectively called a codec or coder. Regarding a speech/audio codec in a communication system, researches are carried out on coding/decoding wideband or superwideband speech and audio signals in order to provide better naturality and clarity away from the coding/decoding of a narrowband speech corresponding to the existing telephone network band. In particular, in order to accommodate various types of network environments, a multi-bit rate coder for supporting several transfer rates has been proposed, and a coder for supporting the multi-bit rates and also supporting an embedded variable bit rate that provides bandwidth extensibility for accommodating signals having several bandwidths and bit rate extensibility having compatibility between transfer rates has also been proposed. The embedded variable bit rate coder is configured so that a bit stream having a high transfer rate includes a bit stream having a low transfer rate. The embedded variable bit rate coder hierarchically performs coding in order to support the bit stream structure.

Furthermore, in the speech/audio codec of a recent communication system, coding/decoding performance for an audio signal, such as music, is considered as an important factor according to an increase in the bandwidth of a signal. To this end, a hybrid coding scheme for splitting all signal bands into low bands and high bands and applying waveform coding and Code Excited Linear Prediction (hereinafter referred to as ‘CELP’) coding to low band signals and transform coding to high band signals is being used.

When coding a speech and audio signal, the speech/audio codecs transform the speech and audio signal from a time domain to a frequency domain by way of a Modified Discrete Cosine Transform (hereinafter referred to as an ‘MDCT’) or a Discrete Fourier Transform (hereinafter referred to as a ‘DFT’) and quantize the transformed speech and audio signal.

If a speech and audio signal is coded using a speech/audio codec in a current communication system, the speech and audio signal must be transformed from a time domain to a frequency domain and then quantized as described above. However, a scheme for quantizing a speech and audio signal in a frequency domain by using a current speech/audio codec, in particular, a detailed scheme for quantizing the frequency coefficients of a speech and audio signal by using a speech/audio codec has not been proposed. In this case, there are problems in that coding performance for a speech and audio signal is deteriorated and voice and audio services having high quality are not provided to users because the coding of the speech and audio signal is not normally performed by a speech/audio codec.

In order to provide voice and audio services having high quality in a communication system, there is a need for a scheme for normally coding a speech and audio signal based on a speech/audio codec by quantizing the frequency coefficients of the speech and audio signal, transformed into a speech and audio signal in a frequency domain, by using the speech/audio codec.

### SUMMARY OF THE INVENTION

An embodiment of the present invention is directed to providing a codec apparatus and method for coding a signal in a communication system.

Another embodiment of the present invention is directed to providing a codec apparatus and method for coding a speech and audio signal by using a speech/audio codec in a communication system.

Yet another embodiment of the present invention is directed to providing a signal codec apparatus and method for normally coding a speech and audio signal based on a speech/audio codec by quantizing the frequency coefficients of the speech and audio signal, transformed into a speech and audio signal in a frequency domain, using the speech/audio codec when coding the speech and audio signal in a communication system.

Yet further another embodiment of the present invention is directed to providing a signal codec apparatus and method, which can normally code a speech and audio signal based on a speech/audio codec and improve voice and audio QoSs by quantizing the frequency coefficients of the speech and audio signal, transformed into a speech and audio signal in a frequency domain by way of an MDCT, using the speech/audio codec with consideration taken of characteristic of sub-bands when coding the speech and audio signal in a communication system.

In accordance with an embodiment of the present invention, a codec apparatus for coding a signal in a communication system includes a transformer configured to transform a speech and audio signal in a time domain into a speech and audio signal in a frequency domain and calculate the frequency coefficients of the speech and audio signal, a band splitter configured to split the frequency coefficients by a plurality of sub-bands and calculate the sub-band coefficients of the respective sub-bands from the frequency coefficients, and a sub-band coefficient quantizer configured to quantize the sub-band coefficients depending on a characteristic of the plurality of sub-bands and calculate sub-band quantization indices by quantizing the sub-band coefficients.

In accordance with another embodiment of the present invention, a method of a codec apparatus coding a signal in a communication system includes transforming a speech and audio signal in a time domain into a speech and audio signal in a frequency domain and calculating the frequency coefficients of the speech and audio signal, splitting the frequency coefficients by a plurality of sub-bands and calculating the sub-band coefficients of the respective sub-bands from the frequency coefficients, and quantizing the sub-band coefficients depending on a characteristic of the plurality of sub-bands and calculating sub-band quantization indices by quantizing the sub-band coefficients.

### BRIEF DESCRIPTION OF THE DRAWINGS

FIG. 1 is a schematic diagram showing the structure of a codec apparatus in a communication system in accordance with an embodiment of the present invention.

FIGS. 2, 3, and 5 are schematic diagrams showing the structures of the sub-band coefficient quantizers of the codec apparatus in a communication system in accordance with embodiments of the present invention.

FIG. 4 is a schematic diagram showing the structure of a gain-shape quantizer in the sub-band coefficient quantizer of the codec apparatus in a communication system in accordance with an embodiment of the present invention.

FIG. 6 is a schematic diagram showing an operation of the codec apparatus in a communication system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes a signal codec apparatus and method in a communication system. Although embodiments of the present invention propose a codec apparatus and method for coding speech and audio signals for providing various types of QoSs, for example, speech and audio services in a communication system, the proposed codec of the present invention can also be likewise applied to cases where signals corresponding to other services are coded.

Furthermore, embodiments of the present invention propose a codec apparatus and method for coding speech and audio signals in a communication system. In an embodiment of the present invention, when coding a speech and audio signal, a speech/audio codec normally codes the speech and audio signal by quantizing the speech and audio signal transformed into a speech and audio signal in a frequency domain.

Furthermore, in an embodiment of the present invention, the speech/audio codec of a communication system normally codes a speech and audio signal by quantizing the speech and audio signal transformed into a speech and audio signal in a frequency domain by way of an MDCT or a DFT and thus provides voice and audio services having high quality. In the embodiment of the present invention, an example in which a speech/audio codec transforms a speech and audio signal into a speech and audio signal in a frequency domain by way of an MDCT has been chiefly described. A codec based on a speech/audio codec proposed by the present invention can be likewise applied to examples in which a speech and audio signal is transformed into a speech and audio signal in a frequency domain by way of other transform methods as well as the example in which the speech and audio signal is transformed into the speech and audio signal in a frequency domain by way of the DFT.

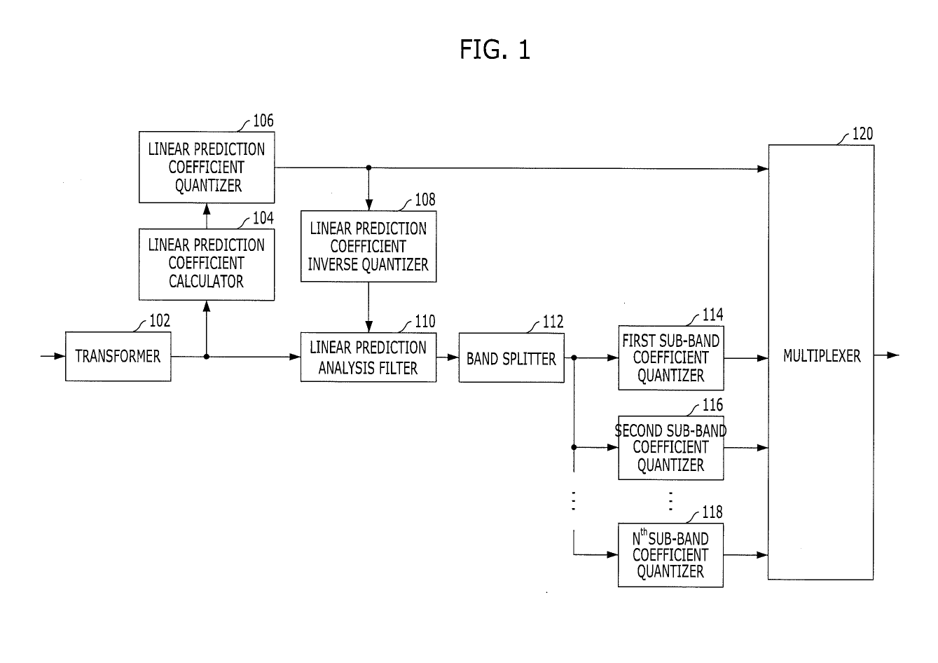

Furthermore, in a communication system in accordance with an embodiment of the present invention, a speech/audio codec normally codes a speech and audio signal by quantizing the frequency coefficients of the speech and audio signal transformed into a speech and audio signal in a frequency domain, for example, the speech and audio signal transformed into a speech and audio signal in a frequency domain by way of an MDCT on the basis of linear prediction and thus provides voice and audio services having high quality because coding performance for the speech and audio signal is improved. In a communication system accordance with an embodiment of the present invention, a speech/audio codec quantizes the frequency coefficients of a speech and audio signal, transformed into a speech and audio signal in a frequency domain by way of an MDCT, by taking a characteristic of sub-bands into consideration on the basis of linear prediction. Accordingly, a quantization error for the frequency coefficients of the speech and audio signal can be minimized, coding performance for the speech and audio signal based on the speech/audio codec can be improved, and thus voice and audio services having high quality can be provided. The codec apparatus of a speech/audio codec in a communication system in accordance with an embodiment of the present invention is described in more detail below with reference to FIG. 1.

FIG. 1 is a schematic diagram showing the structure of a codec apparatus in a communication system in accordance with an embodiment of the present invention.

Referring to FIG. 1, the codec apparatus includes a transformer 102 for transforming a speech and audio signal in a time domain into a speech and audio signal in a frequency domain, a linear prediction coefficient calculator 104 for calculating linear prediction coefficients by using the frequency coefficients of the speech and audio signal in the frequency domain, a linear prediction coefficient quantizer 106 for quantizing the linear prediction coefficients, a linear prediction coefficient inverse quantizer 108 for calculating quantized linear prediction coefficients from linear prediction coefficient quantization indices calculated by the linear prediction coefficient quantizer 106, a linear prediction analysis filter 110 for calculating residual frequency coefficients for the frequency coefficients by using the quantized linear prediction coefficients, a band splitter 112 for splitting the residual frequency coefficients into sub-bands and calculating the sub-band coefficients of the sub-bands, sub-band coefficient quantizers, that is, a first sub-band coefficient quantizer 114, a second sub-band coefficient quantizer 116, . . . , an N^{th} sub-band coefficient quantizer 118 for quantizing the sub-band coefficients by sub-bands, and a multiplexer 120 for outputting a bit stream by multiplexing the sub-band quantization indices of the sub-band coefficients quantized by the sub-band coefficient quantizers and the linear prediction coefficient quantization indices.

More particularly, the transformer 102 transforms the speech and audio signal, received in the time domain, into the speech and audio signal in the frequency domain, for example, by way of an MDCT and calculates the frequency coefficients of the speech and audio signal in the frequency domain, for example, the MDCT coefficients. In an embodiment of the present invention, the transformer 102 has been illustrated as calculating the frequency coefficients, that is, the MDCT coefficients of the speech and audio signal by transforming the speech and audio signal into the speech and audio signal in the frequency domain by way of the MDCT as described above, but the transformer 102 may calculate the frequency coefficients of the speech and audio signal by transforming the speech and audio signal into the speech and audio signal in the frequency domain by using a transform method other than the MDCT, for example, a transform method, such as a DFT.

As described above, the transformer 102 transforms the speech and audio signal in the time domain into the speech and audio signal in the frequency domain by way of the MDCT and calculates the frequency coefficients of the speech and audio signal, that is, the MDCT coefficients. The MDCT coefficients can be represented by Equation 1 below.

$$X ( k ) = {\sum }_{n = 0}^{2 N - 1} w ( n ) x ( n ) cos ( \frac{π}{N} ( n + \frac{1}{2} + \frac{N}{2} ) ( k + \frac{1}{2} ) ) , \\ k = 0 , 1 , … , ( N - 1 ) \qquad [ Equation 1 ]$$

In Equation 1, N indicates the length of the frame of a speech and audio signal to be processed by block when transforming the speech and audio signal in a time domain into a speech and audio signal in a frequency domain by way of the MDCT, w(n) indicates a window function, and x(n) indicates the speech and audio signal in the time domain. Furthermore, X(k) indicates MDCT coefficients, that is, frequency coefficients, n indicates the index of the time domain, and k indicates the index of the frequency domain.

The linear prediction coefficient calculator 104 calculates linear prediction coefficients by using the frequency coefficients calculated by the transformer 102, that is, the MDCT coefficients. Here, the linear prediction coefficient calculator 104 calculates coefficient sets {aᵢ}, i=1, . . . , p that minimize an error sum between real MDCT coefficients X(k) and the prediction value \tilde{X}(k) of current MDCT coefficients obtained as the weight sum of past p MDCT coefficients as shown in Equation 2 in relation to the frequency coefficients, that is, the MDCT coefficients. That is, the linear prediction coefficient calculator 104 calculates a set of coefficients, that is, the linear prediction coefficients having a minimum error between the current MDCT coefficients predicted from the past p MDCT coefficients and the real MDCT coefficients calculated by the transformer 102 in relation to the frequency coefficients, that is, the MDCT coefficients.

$$E = {\sum }_{k = 0}^{N - 1} {\{ X ( k ) - \tilde{X} ( k ) \}}^{2} = {\sum }_{k = 0}^{N - 1} {\{ X ( k ) - {\sum }_{i = 1}^{p} {a}_{i} X ( k - i ) \}}^{2} \qquad [ Equation 2 ]$$

In Equation 2, {aᵢ} indicates the linear prediction coefficients, and p indicates the degree of linear prediction. Here, the linear prediction coefficient calculator 104 calculates the linear prediction coefficients from the frequency coefficients by using a self-correlation function and a Levinson-Durbin) algorithm.

The linear prediction coefficient quantizer 106 quantizes the linear prediction coefficients and calculates linear prediction coefficient quantization indices by using the quantized linear prediction coefficients. More particularly, the linear prediction coefficient quantizer 106 transforms the linear prediction coefficients into Line Spectrum Pair (hereinafter referred to as an ‘LSP’) coefficients and performs vector quantization on the LSP coefficients by using a previously trained quantization table. That is, the linear prediction coefficient quantizer 106 calculates the linear prediction coefficient quantization indices by performing vector quantization on the LSP coefficients by using the quantization table as described above.

The linear prediction coefficient inverse quantizer 108 restores quantized LSP coefficients from the linear prediction coefficient quantization indices by querying the quantization table, transforms the restored LSP coefficients into linear prediction coefficients, and calculates quantized linear prediction coefficients by using the linear prediction coefficients.

The linear prediction analysis filter 110 calculates residual frequency coefficients, for example, residual MDCT coefficients by using the frequency coefficients calculated by the transformer 102, that is, the MDCT coefficients, and the quantized linear prediction coefficients. Here, the residual frequency coefficients, that is, the residual MDCT coefficients, can be represented by Equation 3 below.

$$R ( k ) = X ( k ) - {\sum }_{i = 1}^{p} {\hat{a}}_{i} X ( k - i ) , \\ k = 0 , 1 , … , ( N - 1 ) \qquad [ Equation 3 ]$$

In Equation 3, {âᵢ}, i=1, . . . , p indicates the quantized linear prediction coefficients, and R(k) indicates the residual frequency coefficients, that is, the residual MDCT coefficients.

The band splitter 112 splits the residual frequency coefficients, that is, the MDCT residual coefficients, into specific sub-bands, for example, splits the MDCT residual coefficients into N_{b} sub-bands and calculates sub-band coefficients corresponding to the respective N_{b} sub-bands. Here, the band splitter 112 splits the entire band of the MDCT residual coefficients into sub-bands at specific intervals or splits the entire band into sub-bands on the basis of a critical band by taking a characteristic of a user who is supplied with voice and audio services, for example, the auditory characteristic of the user into consideration. If the band splitter 112 splits the entire band of the MDCT residual coefficients into the N_{b} sub-bands, the band splitter 112 calculates the sub-band coefficients of the respective N_{b} sub-bands. The sub-band coefficients can be represented by Equation 4 below.

R_{b}(k)=R(b×M+k),b=0, 1, . . . , (N_{b}−1),k=0, 1, . . . , (M−1) [Equation 4]

In Equation 4, b indicates a sub-band index, M indicates an MDCT coefficient M=N/N_{b} corresponding to each sub-band, the N_{b} indicates the number of sub-bands, and R_{b}(k) indicates a sub-band coefficient corresponding to a specific b^{th} sub-band.

Furthermore, the band splitter 112, as represented by Equation 4, outputs the sub-band coefficients of the N_{b} sub-bands to the sub-band coefficient quantizers 114, 116, . . . , 118. In particular, the band splitter 112 outputs the sub-band coefficients to the respective sub-band coefficient quantizers.

That is, the sub-band coefficient quantizers receive respective sub-band coefficients from the band splitter 112. More particularly, the first sub-band coefficient quantizer 114 receives a first sub-band coefficient from the band splitter 112, the second sub-band coefficient quantizer 116 receives a second sub-band coefficient from the band splitter 112, and the N^{th} sub-band coefficient quantizer 118 receives an N^{th} sub-band coefficient from the band splitter 112.

Furthermore, the sub-band coefficient quantizers 114, 116, . . . , 118 calculate sub-band quantization indices by quantizing the respective sub-band coefficients. More particularly, the first sub-band coefficient quantizer 114 quantizes the first sub-band coefficient and calculates a first sub-band quantization index by using the quantized first sub-band coefficient, the second sub-band coefficient quantizer 116 quantizes the second sub-band coefficient and calculates a second sub-band quantization index by using the quantized second sub-band coefficient, and the N^{th} sub-band coefficient quantizer 118 quantizes the N^{th} sub-band coefficient and calculates an N^{th} sub-band quantization index by using the quantized N^{th} sub-band coefficient.

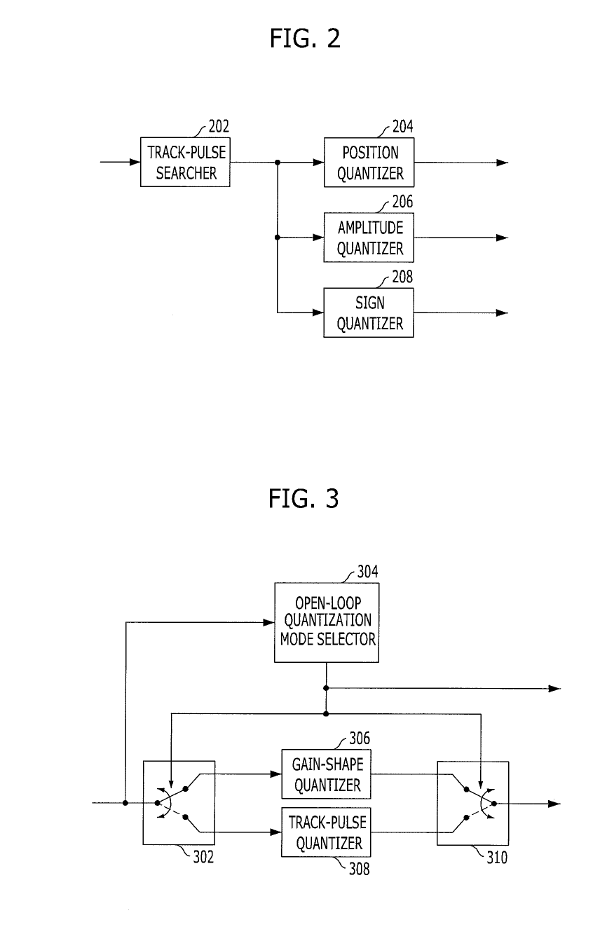

The multiplexer 120 outputs a bit stream by multiplexing the linear prediction coefficient quantization indices calculated by the linear prediction coefficient quantizer 106 and the sub-band quantization indices calculated by the sub-band coefficient quantizers 114, 116, . . . , 118. The sub-band coefficient quantizers of the codec apparatus in a communication system in accordance with an embodiment of the present invention are described in more detail below with reference to FIG. 2.

FIG. 2 is a schematic diagram showing the structure of the sub-band coefficient quantizer of the codec apparatus in a communication system in accordance with an embodiment of the present invention. FIG. 2 is a schematic diagram showing the structure of a specific sub-band coefficient quantizer for spitting the residual frequency coefficients of a speech and audio signal, that is, the MDCT coefficients, into sub-bands and quantizing the sub-band coefficients of the respective sub-bands in the codec apparatus of FIG. 1. Furthermore, FIG. 2 is a schematic diagram showing the structure of a sub-band coefficient quantizer for quantizing the sub-band coefficients of frequency coefficients, that is, the MDCT coefficients, by using track-pulse coding when the MDCT coefficients are quantized based on linear prediction as described above.

Referring to FIG. 2, the sub-band coefficient quantizer includes a track-pulse searcher 202 for searching for pulses in a track structure in relation to sub-band coefficients according to track-pulse coding as described above and calculating information on the searched pulses, a position quantizer 204 for calculating position indices by encoding position information on the position of the pulses searched in each track of the sub-band coefficients, a amplitude quantizer 206 for calculating amplitude indices by quantizing amplitude components on the amplitude of the pulses searched in each track of the sub-band coefficients, and a sign quantizer 208 for calculating sign indices by quantizing sign components of the pulses searched in each track of the sub-band coefficients. Here, the information on the pulses calculated by the track-pulse searcher 202 depending on the pulses of the track structure for the sub-band coefficient includes information on the position, amplitude, and sign of each of the pulses searched in each track of the sub-band coefficients.

More particularly, as described above, when the sub-band coefficient quantizer quantizes the sub-band coefficients for the frequency coefficients based on linear prediction, that is, the MDCT coefficients, by way of track-pulse coding, the track-pulse searcher 202 searches for pulses for the number of optimized coefficients determined using an already predetermined track structure, that is, the sub-band coefficients, and obtains information on the pulses. For example, if the number of MDCT coefficients corresponding to a specific sub-band is 40 (M=40), each of 5 tracks includes 8 coefficients, and the track-pulse searcher 202 searches for pulses per track, a track structure is represented by Table below.

TABLE 1

| PULSE | SIGN | POSITION [Ωₜ] |
|---|---|---|
| i₀ | s₀: ±1 | 0, 5, 10, 15, 20, 25, 30, 35 |
| i₁ | s₁: ±1 | 1, 6, 11, 16, 21, 26, 31, 36 |
| i₂ | s₂: ±1 | 2, 7, 12, 17, 22, 27, 32, 37 |
| i₃ | s₃: ±1 | 3, 8, 13, 18, 23, 28, 33, 38 |
| i₄ | s₄: ±1 | 4, 9, 14, 19, 24, 29, 34, 39 |

Accordingly, the track-pulse searcher 202 searches for the position of pulses in each track, and the position of the pulses in each track can be represented by Equation 5 below.

$${p}_{t} = {arg max}_{k ∈ {Ω}_{t}} \vert {R}_{b} ( k ) \vert , \\ t = 0 , 1 , … , ( {N}_{T} - 1 ) \qquad [ Equation 5 ]$$

In Equation 5, Pₜ, indicates the position of pulses in a specific t^{th} track N_{T} indicates the number of tracks (e.g., N_{T}=5), and Ωₜ indicates a set of coefficient indices corresponding to the specific t^{th} track (e.g., in the case of a 0^{th} track, U₀={0, 5, 10, 15, 20, 25, 30, 35}).

When the track-pulse searcher 202 searches for the pulses of each track by using information on the pulses according to the track-pulse search, the position quantizer 204 calculates position indices by encoding position information on the position of the pulses searched in each track of the sub-band coefficients. Here, the position indices can be represented by Equation 6 below.

$${I}_{p , t} = \frac{( {p}_{t} - t )}{{N}_{T}} , \\ t = 0 , 1 , … , ( {N}_{T} - 1 ) \qquad [ Equation 6 ]$$

In Equation 6, I_{p,t} indicates the position indices calculated by coding the information on the position of the pulses searched in each track of the sub-band coefficients.

The pulses R_{b}(pₜ), t=0, 1, . . . , N_{T}−1 searched in each track of the sub-band coefficient is split into amplitude components on the amplitude of the pulses and sign components on the sign of the pulses and then encoded. The amplitude quantizer 206 quantizes the information on the amplitude of the pulses R_{b}(pₜ), t=0, 1, . . . , N_{T}−1 searched in each track of the sub-band coefficients and calculates amplitude indices I_{a,t}, t=0, 1, . . . , N_{T}−1 by using the quantized amplitude components. In this case, the amplitude quantizer 206 performs scalar quantization on the amplitude of the pulses R_{b}(pₜ), t=0, 1, . . . , N_{T}−1 searched in each track of the sub-band coefficients individually or groups the amplitudes of the pulses R_{b}(pₜ), t=0, 1, . . . , N_{T}−1 searched in the tracks of the sub-band coefficients and performs vector quantization in each of the groups.

The sign quantizer 208 quantizes the sign components of the pulses R_{b}(pₜ), t=0, 1, . . . , N_{T}−1 searched in each track of the sub-band coefficients and calculates sign indices by using the quantized sign components. The sign indices can be represented by Equation 7 below.

$${I}_{s , t} = \{ \begin{matrix}+ 1 , & if {R}_{b} ( {p}_{t} ) \geq 0 \\ - 1 , & if {R}_{b} ( {p}_{t} ) < 0\end{matrix} , \\ t = 0 , 1 , … , ( {N}_{T} - 1 ) \qquad [ Equation 7 ]$$

In Equation 7, I_{s,t} indicates the sign indices quantized by encoding the sign of the pulses R_{b}(pₜ), t=0, 1, . . . , N_{T}−1 searched in each track of the sub-band coefficients.

As described above, in a communication system in accordance with an embodiment of the present invention, when quantizing frequency coefficients, that is, MDCT coefficients, based on linear prediction as described above, the sub-band coefficient quantizer of the codec apparatus quantizes sub-band coefficients for the MDCT coefficients by way of single track-pulse coding without taking a characteristic of the sub-bands of the MDCT coefficients into consideration. Accordingly, there is a limit to normally coding a speech and audio signal by using a speech/audio codec. That is, if the MDCT coefficients are quantized by single track-pulse coding without taking a characteristic of the sub-bands of the MDCT coefficients into consideration as described above, there is a limit to providing voice and audio services having high quality.

For this reason, in a communication system in accordance with an embodiment of the present invention, frequency coefficients are quantized based on linear prediction by taking a characteristic of the sub-bands of the frequency coefficients, that is, MDCT coefficients, as described above. Accordingly, a quantization error for the frequency coefficients of a speech and audio signal can be minimized, coding performance for the speech and audio signal based on a speech/audio codec can be improved, and thus voice and audio services having high quality can be provided. The sub-band coefficient quantizers of the codec apparatus in a communication system in accordance with an embodiment of the present invention are described in more detail below with reference to FIG. 3.

FIG. 3 is a schematic diagram showing the structure of the sub-band coefficient quantizer of the codec apparatus in a communication system in accordance with an embodiment of the present invention. FIG. 3 is a schematic diagram showing the structure of a specific sub-band coefficient quantizer for spitting the residual frequency coefficients of a speech and audio signal, that is, the MDCT coefficients, into sub-bands and quantizing the sub-band coefficients of the respective sub-bands in the codec apparatus of FIG. 1. Furthermore, FIG. 3 is a schematic diagram showing the structure of an open-loop sub-band coefficient quantizer for quantizing the sub-band coefficients of the frequency coefficients, that is, the MDCT coefficients, by using a selective quantization method for the sub-bands when the MDCT coefficients are quantized based on linear prediction as described above.

Referring to FIG. 3, the sub-band coefficient quantizer includes an open-loop quantization mode selector 304 for calculating a quantization mode value according to a characteristic of the sub-band coefficients, a gain-shape quantizer 306 for splitting the sub-band coefficients into a gain corresponding to an energy envelope of the sub-band coefficients and a shape corresponding to a form of the sub-band coefficients based on the quantization mode value and calculating gain-shape indices by quantizing the gain and the shape separately, a track-pulse quantizer 308 for searching for pulses in each track of the sub-band coefficients and calculating track-pulse indices by quantizing the pulses, and switches 302 and 310 for selecting the quantization of the sub-band coefficients by the gain-shape quantizer 306 or the track-pulse quantizer 308 based on the quantization mode value.

More particularly, the open-loop quantization mode selector 304 calculates the quantization mode value on which the quantization of the sub-band coefficients by the gain-shape quantizer 306 or the track-pulse quantizer 308 is selected according to a characteristic of a corresponding sub-band coefficient of the sub-band coefficients. For example, the open-loop quantization mode selector 304 calculates the quantization mode value based on the spectral flatness scale of the sub-band coefficients, that is, a characteristic of the sub-band coefficients. Here, the open-loop quantization mode selector 304 calculates the quantization mode value by using a Spectral Flatness Measure (hereinafter referred to as ‘SFM’) or kurtosis indicative of the spectral flatness scale of the sub-band coefficients. The SFM can be represented by Equation 8 below, and the kurtosis can be represented by Equation 9 below.

$$\begin{matrix}S F {M}_{b} = \frac{{( {\prod }_{k = 0}^{M - 1} \vert {R}_{b} ( k ) \vert )}^{1 / M}}{\frac{1}{M} {\sum }_{k = 0}^{M - 1} \vert {R}_{b} ( k ) \vert} , \\ b = 0 , 1 , … , ( {N}_{b} - 1 ) & [ Equation 8 ] \\ {Kurt}_{b} = \frac{\frac{1}{M} {\sum }_{k = 0}^{M - 1} {( {R}_{b} ( k ) - {\overline{R}}_{b} )}^{4}}{{( \frac{1}{M} {\sum }_{k = 0}^{M - 1} {( {R}_{b} ( k ) - {\overline{R}}_{b} )}^{2} )}^{2}} - 3 , \\ b = 0 , 1 , … , ( {N}_{b} - 1 ) & [ Equation 9 ]\end{matrix}$$

In Equations 8 and 9, SFM_{b} indicates the SFM of a specific b^{th} sub-band, Kurt_{b} indicates the kurtosis of the specific b^{th} sub-band, and R̅_{b} indicates the mean value of the residual MDCT coefficients of the specific b^{th} sub-band.

That is, the open-loop quantization mode selector 304 compares the aforementioned spectral flatness scale, that is, the SFM or kurtosis, with a predetermined threshold and calculates the quantization mode value determined based on a result of the comparison. The quantization mode value can be represented by Equation 10 below.

$${Mode}_{b} = \{ \begin{matrix}1 , & if S F {M}_{b} \geq {TH}_{S F M} or {Kurt}_{b} < {TH}_{Kurt} \\ 0 , & if S F {M}_{b} < {TH}_{S F M} or {Kurt}_{b} \geq {TH}_{Kurt}\end{matrix} , \\ b = 0 , 1 , … , ( {N}_{b} - 1 ) \qquad [ Equation 10$$

In Equation 10, Mode_{b} indicates the quantization mode value of the specific b^{th} sub-band, TH_{SFM} indicate the threshold of the SFM, and TH_{Kurt} indicates the threshold of the kurtosis.

The switches 302 and 310 select the quantization of the sub-band coefficients based on the quantization mode value calculated by the open-loop quantization mode selector 304 as described above so that either the gain-shape quantizer 306 or the track-pulse quantizer 308 quantizes the sub-band coefficients and calculates the sub-band quantization indices by using the quantized sub-band coefficients.

For example, if the sub-band coefficients are flat like noise (i.e., Mode_{b}=1), that is, the spectral flatness scale of the sub-band coefficients is great (i.e., the SFM is greater than the threshold or the kurtosis is smaller than the threshold), the open-loop quantization mode selector 304 quantizes the sub-band coefficients and calculates the quantization mode value by using the quantized sub-band coefficients so that the gain-shape quantizer 306 calculates the sub-band quantization indices. Furthermore, if the sub-band coefficients are not flat like a tone signal (i.e., Mode_{b}=0), that is, the spectral flatness scale of the sub-band coefficients is small (i.e., the SFM is smaller than the threshold or the kurtosis is greater than the threshold), the open-loop quantization mode selector 304 calculates the quantization mode value on which the track-pulse quantizer 308 can quantize the sub-band coefficients and calculate the sub-band quantization indices by using the quantized sub-band coefficients. That is, the switches 302 and 310 select one of the gain-shape quantizer 306 and the track-pulse quantizer 308 based on the quantization mode value as described above.

The gain-shape quantizer 306 splits the sub-band coefficients into a gain corresponding to an approximate energy envelope of the sub-band coefficients and a shape corresponding to a detailed form of the sub-band coefficients, quantizes the gain and the shape, and calculates gain-shape indices based on the quantized gain and shape. That is, the gain-shape quantizer 306 quantizes the gain of the sub-band coefficients and the shape of the sub-band coefficients separately and calculates the gain-shape indices based on the quantized gain and shape. The gain-shape indices are outputted as the sub-band quantization indices.

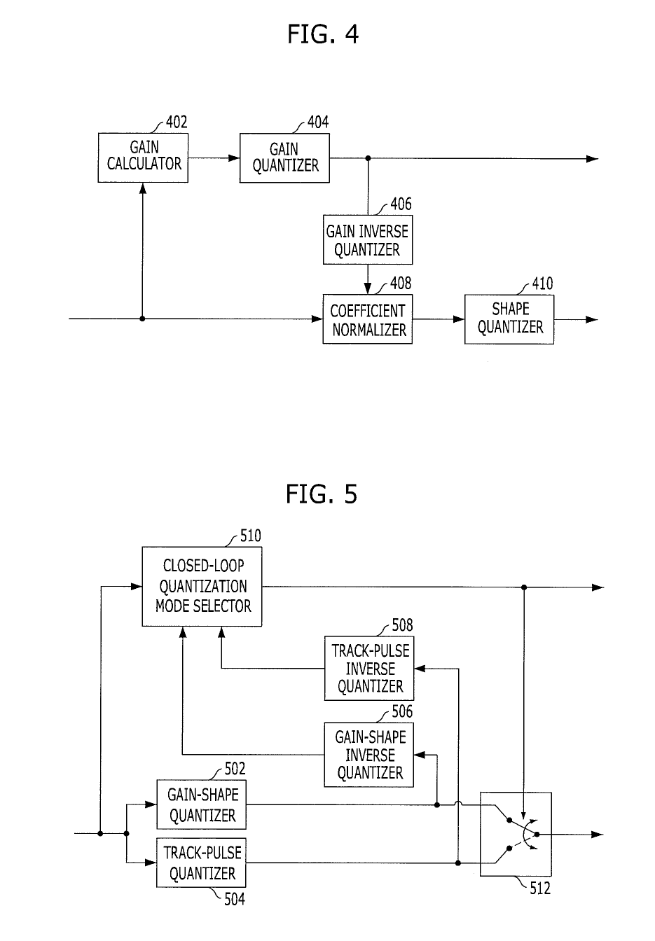

The track-pulse quantizer 308 splits the sub-band coefficients into a plurality of tracks, searches for pulses having a number that is determined in each track of the sub-band coefficients, that is, searches for pulses in each track of the sub-band coefficient, quantizes the searched pulses, and calculates track-pulse indices by using the quantized pulses. The track-pulse indices are outputted as the sub-band quantization indices. That is, the track-pulse quantizer 308 calculates the sub-band quantization indices like the sub-band coefficient quantizer of FIG. 2. The quantization of the sub-band coefficients using track-pulse coding has been described in detail with reference to FIG. 2, and a detailed description thereof is omitted. In a communication system in accordance with an embodiment of the present invention, the gain-shape quantizer in the sub-band coefficient quantizer of the codec apparatus is described in more detail below with reference to FIG. 4.

FIG. 4 is a schematic diagram showing the structure of the gain-shape quantizer in the sub-band coefficient quantizer of the codec apparatus in a communication system in accordance with an embodiment of the present invention. FIG. 4 shows a detailed construction of the gain-shape quantizer 306 shown in FIG. 3.

Referring to FIG. 4, the gain-shape quantizer includes a gain calculator 402 for calculating the gain of the sub-band coefficients, a gain quantizer 404 for calculating gain indices by quantizing the gain, a gain inverse quantizer 406 for restoring a quantized gain from the gain indices, a coefficient normalizer 408 for calculating shape coefficients by normalizing the sub-band coefficients by way of the quantized gain, and a shape quantizer 410 for calculating shape indices by quantizing the shape coefficients. Here, as the gain indices and the shape indices are calculated and outputted by the gain quantizer 404 and the shape quantizer 410, the gain-shape indices are outputted from the gain-shape quantizer 306.

More particularly, the gain calculator 402 calculates the gain of the sub-band coefficients. The gain of the sub-band coefficients can be represented by Equation 11.

$${g}_{b} = \sqrt{\frac{1}{M} {\sum }_{k = 0}^{M - 1} {( {R}_{b} ( k ) )}^{2}} , \\ b = 0 , 1 , … , ( {N}_{b} - 1 ) \qquad [ Equation 11 ]$$

In Equation 1, g_{b} indicates the gain of a specific b^{th} sub-band.

The gain quantizer 404 quantizes the gain of the sub-band coefficients and calculates the gain indices based on the quantized gain. For example, the gain quantizer 404 calculates the gain indices by performing scalar quantization on the gain of the sub-band coefficients by sub-bands or groups the gains of the sub-band coefficients and calculates the gain indices by performing vector quantization on the grouped gains.

The gain inverse quantizer 406 restores a quantized gain from the gain indices.

The coefficient normalizer 408 normalizes the sub-band coefficients by using the quantized gain and then calculates the shape coefficients. More particularly, the coefficient normalizer 408 normalizes the sub-band coefficients by using the quantized gain and calculates the shape coefficients by using the normalized sub-band coefficients. The sub-band coefficients normalized by the coefficient normalizer 408, that is, the shape coefficients, can be represented by Equation 12 below.

$${\tilde{R}}_{b} ( k ) = \frac{{R}_{b} ( k )}{{\hat{g}}_{b}} , \\ k = 0 , 1 , … , ( M - 1 ) , \\ b = 0 , 1 , … , ( {N}_{b} - 1 ) \qquad [ Equation 12 ]$$

In Equation 12, \tilde{R}_{b}(k) indicates the sub-band coefficients normalized by the coefficient normalizer 408, that is, the shape coefficients, and ĝ_{b} indicatges the quantized gain.

The shape quantizer 410 quantizes the shape coefficients and calculates the shape indices by using the quantized shape coefficients. The shape indices calculated by the shape quantizer 410 and the gain indices calculated by the gain quantizer 404, as described above, become the gain-shape indices outputted from the gain-shape quantizer 306. The sub-band coefficient quantizers of the codec apparatus in a communication system in accordance with an embodiment of the present invention are described in more detail below with reference to FIG. 5.

FIG. 5 is a schematic diagram showing the structure of the sub-band coefficient quantizer of the codec apparatus in a communication system in accordance with an embodiment of the present invention. FIG. 5 is a schematic diagram showing the structure of a specific sub-band coefficient quantizer for spitting the residual frequency coefficients of a speech and audio signal, that is, the MDCT coefficients, into sub-bands and quantizing the sub-band coefficients of the respective sub-bands in the codec apparatus of FIG. 1. Furthermore, FIG. 5 is a schematic diagram showing the structure of a closed-loop sub-band coefficient quantizer for quantizing the sub-band coefficients of the frequency coefficients, that is, the MDCT coefficients, by using a selective quantization method for the sub-bands when the MDCT coefficients are quantized based on linear prediction as described above.

Referring to FIG. 5, the sub-band coefficient quantizer includes a gain-shape quantizer 502 for splitting the sub-band coefficients into a gain corresponding to an energy envelope and a shape corresponding to a form of the sub-band coefficients and calculating gain-shape indices by quantizing the gain and the shape separately, a track-pulse quantizer 504 for searching for pulses in each track of the sub-band coefficients and calculating track-pulse indices by quantizing the pulses, a gain-shape inverse quantizer 506 for restoring a first quantized sub-band coefficient by decoding the gain-shape indices calculated by the gain-shape quantizer 502, a track-pulse inverse quantizer 508 for restoring a second quantized sub-band coefficient by decoding the track-pulse indices calculated by the track-pulse quantizer 504, a closed-loop quantization mode selector 510 for comparing the first quantized sub-band coefficient with the second quantized sub-band coefficient and calculating an optimum quantization mode value based on a result of the comparison, and a switch 512 for selecting the quantization of the sub-band coefficients by the gain-shape quantizer 502 or the track-pulse quantizer 504 based on the optimum quantization mode value.

The gain-shape quantizer 502 and the track-pulse quantizer 504 have been described in detail above, and a detailed description thereof is omitted. In other words, the gain-shape quantizer 502 and the track-pulse quantizer 504 calculate the gain-shape indices and the track-pulse indices by quantizing the sub-band coefficients like the gain-shape quantizer 306 and the track-pulse quantizer 308 described with reference to FIG. 3.

The gain-shape inverse quantizer 506 decodes the gain-shape indices calculated by the gain-shape quantizer 502 and calculates the first quantized sub-band coefficient by using the decoded gain-shape indices. The track-pulse inverse quantizer 508 decodes the track-pulse indices calculated by the track-pulse quantizer 504 and calculates the second quantized sub-band coefficient by using the decoded track-pulse indices.

The closed-loop quantization mode selector 510 compares the first quantized sub-band coefficient with the second quantized sub-band coefficient and calculates the optimum quantization mode value based on a result of the comparison. In particular, the closed-loop quantization mode selector 510 calculates the optimum quantization mode value by using a quantization error between the quantization of the sub-band coefficients by the gain-shape quantizer 502 and the quantization of the sub-band coefficients by the track-pulse quantizer 504. Here, the first quantized sub-band coefficient and the quantized second sub-band coefficient preferably are sub-band coefficients decoded from a gain-shape index and a track-pulse index that are obtained by quantizing the same sub-band coefficient, from among the sub-bands of the frequency coefficients, that is, the MDCT coefficients.

That is, the closed-loop quantization mode selector 510 calculates the optimum quantization mode value by using a quantization error scale between the gain-shape quantizer 502 and the track-pulse quantizer 504 or a scale, such as a Segmental Signal-to-Noise Ratio (hereinafter referred to as an ‘SSNR’). In other words, the closed-loop quantization mode selector 510 calculates the quantization mode value on which the quantization of the sub-band coefficients by the gain-shape quantizer 502 or the track-pulse quantizer 504 is selected. Here, the quantization error can be represented by Equation 13 below, and the SSNR can be represented by Equation 14.

$$\begin{matrix}{Q}_{b}^{m} = {\sum }_{k = 0}^{M - 1} {( {R}_{b} ( k ) - {\hat{R}}_{b}^{m} ( k ) )}^{2} , \\ b = 0 , 1 , … , ( {N}_{b} - 1 ) , \\ m = 1 , 2 & [ Equation 13 ] \\ S S N {R}_{b}^{m} = 20 {log}_{10} ( \frac{{\sum }_{k = 0}^{M - 1} {( {R}_{b} ( k ) )}^{2}}{{\sum }_{k = 0}^{M - 1} {( {R}_{b} ( k ) - {\hat{R}}_{b}^{m} ( k ) )}^{2}} ) , \\ b = 0 , 1 , … , ( {N}_{b} - 1 ) , \\ m = 1 , 2 & [ Equation 14 ]\end{matrix}$$

In Equations 13 and 14, Q_{b}^{m} indicates a quantization error for an m^{th} optimum quantization mode value of a specific b^{th} sub-band, SSNR_{b}^{m} indicates the SSNR of the m^{th} optimum quantization mode value of the specific b^{th} sub-band, and R_{b}^{m}(k) indicates sub-band coefficients quantized based on the m^{th} optimum quantization mode value of the specific b^{th} sub-band, for example, the first quantized sub-band coefficient and the second quantized sub-band coefficient. Here, the closed-loop quantization mode selector 510 calculates the optimum quantization mode value such that the quantization error is minimized or the one quantizer having a greater SSNR is selected. That is, the closed-loop quantization mode selector 510 calculates the optimum quantization mode value such that the one quantizer that minimizes the quantization error or maximizes the SSNR is selected.

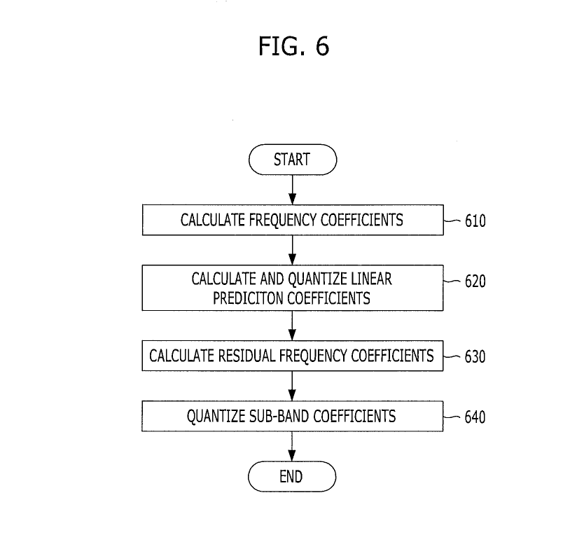

The switch 512 selects the quantization of the sub-band coefficients by the gain-shape quantizer 502 or the track-pulse quantizer 504 based on the optimum quantization mode value calculated by the closed-loop quantization mode selector 510 as described above such that the gain-shape quantizer 502 or the track-pulse quantizer 504 quantizes the sub-band coefficients and calculates the sub-band quantization indices by using the quantized sub-band coefficients. In other words, the switch 512 outputs the gain-shape indices as the sub-band quantization indices or outputs the track-pulse indices as the sub-band quantization indices. An operation of the codec apparatus in a communication system in accordance with an embodiment of the present invention is described in more detail below with reference to FIG. 6.

FIG. 6 is a schematic diagram showing an operation of the codec apparatus in a communication system in accordance with an embodiment of the present invention. FIG. 6 is a schematic diagram showing an operation of the codec apparatus for quantizing frequency coefficients, that is MDCT coefficients, in a communication system in accordance with an embodiment of the present invention.

Referring to FIG. 6, at step 610, the codec apparatus converts a speech and audio signal in a time domain into a speech and audio signal in a frequency domain and calculates the frequency coefficients of the speech and audio signals based on the transformed speech and audio signal as described above. Here, the codec apparatus converts the speech and audio signal in the time domain into the speech and audio signal in the frequency domain by way of the MDCT and calculates the frequency coefficients, that is, MDCT coefficients, by using the converted speech and audio signal.

At step 620, after calculating linear prediction coefficients by using the frequency coefficients, that is, the MDCT coefficients, the codec apparatus quantizes the linear prediction coefficients and calculates linear prediction coefficient quantization indices by using the quantized linear prediction coefficients.

At step 630, after calculating quantized linear prediction coefficients from the linear prediction coefficient quantization indices, the codec apparatus calculates residual frequency coefficients, for example, residual MDCT coefficients by using the frequency coefficients, that is, the MDCT coefficients, and the quantized linear prediction coefficients.

At step 640, the codec apparatus splits the residual frequency coefficients, that is, the MDCT residual coefficients, into sub-bands, calculates the sub-band coefficients of each of the sub-bands from the residual frequency coefficients, and quantizes the sub-band coefficients into sub-band quantization indices. Here, the sub-band coefficients are quantized into the sub-band quantization indices depending on a characteristic of each of the sub-bands. The quantization of the sub-band coefficients has been described in detail above, and a detailed description thereof is omitted.

As described above, in a communication system in accordance with an embodiment of the present invention, the speech/audio codec normally codes a speech and audio signal by quantizing the frequency coefficients of a speech and audio signal transformed into a speech and audio signal in a frequency domain, for example, a speech and audio signal transformed into a speech and audio signal in a frequency domain by way of the MDCT. Accordingly, voice and audio services having high quality can be provided because coding performance for the speech and audio signal can be improved. In particular, in a communication system in accordance with an embodiment of the present invention, the speech/audio codec quantizes the frequency coefficients of a speech and audio signal, transformed into a speech and audio signal in a frequency domain, by way of the MDCT by taking a characteristic of sub-bands into consideration. Accordingly, voice and audio services having high quality can be provided because a quantization error for the frequency coefficients of the speech and audio signal can be minimized and coding performance for the speech and audio signal based on the speech/audio codec can be improved.

While the present invention has been described with respect to the specific embodiments, it will be apparent to those skilled in the art that various changes and modifications may be made without departing from the spirit and scope of the invention as defined in the following claims.

What is claimed is:

1. A codec apparatus for coding a signal in a communication system, the codec apparatus comprising:
a transformer configured to transform a speech and audio signal in a time domain into a speech and audio signal in a frequency domain and calculate frequency coefficients of the speech and audio signal;
a band splitter configured to split the frequency coefficients by a plurality of sub-bands and calculate sub-band coefficients of the respective sub-bands from the frequency coefficients; and
a sub-band coefficient quantizer configured to quantize the sub-band coefficients depending on a characteristic of the plurality of sub-bands and calculate sub-band quantization indices by quantizing the sub-band coefficients.

2. The codec apparatus of claim 1, wherein the sub-band coefficient quantizer comprises:
a mode selector configured to calculate a quantization mode value by taking the characteristic of the plurality of sub-bands into consideration;
a first quantizer configured to quantize the sub-band coefficients based on the quantization mode value and generate gain-shape indices as the sub-band quantization indices; and
a second quantizer configured to quantize the sub-band coefficients based on the quantization mode value and generate track-pulse indices as the sub-band quantization indices.

3. The codec apparatus of claim 2, wherein the mode selector calculates the quantization mode value by using a Spectral Flatness Measure (SFM) or kurtosis representing a spectral flatness scale of the sub-band coefficients.

4. The codec apparatus of claim 3, wherein:
when the spectral flatness scale of the sub-band coefficients is larger than a predefined threshold, the first quantizer calculates the sub-band quantization indices; and
when the spectral flatness scale of the sub-band coefficients is smaller than the predefined threshold, the second quantizer calculates the sub-band quantization indices.

5. The codec apparatus of claim 2, wherein the mode selector calculates the quantization mode value by using two sets of the quantized sub-band coefficients decoded from the gain-shape indices and the track-pulse indices, respectively.

6. The codec apparatus of claim 5, wherein the mode selector calculates the quantization mode value by computing each Segmental Signal-to-Noise Ratio (SSNR) between unquantized sub-band coefficients and respective quantized sub-band coefficients obtained by the first quantizer and the second quantizer.

7. The codec apparatus of claim 6, wherein the mode selector calculates the quantization mode value so that a quantizer with minimum quantization error or maximum SSNR, among the first quantizer and the second quantizer, calculates the sub-band quantization indices.

8. The codec apparatus of claim 2, wherein the first quantizer comprises:
a gain calculator configured to calculate a gain of the sub-band coefficients;
a gain quantizer configured to quantize the gain of the sub-band coefficients and generate gain indices corresponding to the quantized gain;
a coefficient normalizer configured to normalize the sub-band coefficients using a gain quantized by restoring the gain indices and generate shape coefficients; and
a shape quantizer configured to quantize the shape coefficients and generate shape indices corresponding to the quantized shape coefficients.

9. The codec apparatus of claim 2, wherein the second quantizer comprises:
a searcher configured to arrange the sub-band coefficients based on a track structure, search for a track-pulse of the sub-band coefficients, and search for pulses per each track of the sub-band coefficients;
a position quantizer configured to encode position information on a position of the pulses searched in each track of the plurality of sub-bands and generate position indices;
a amplitude quantizer configured to quantize amplitude components of the pulses searched in each track of the plurality of sub-bands and generate amplitude indices; and
a sign quantizer configured to quantize sign components of the pulses searched in each track of the plurality of sub-bands and generate sign indices.

10. The codec apparatus of claim 1, further comprising:
a linear prediction coefficient calculator configured to calculate linear prediction coefficients by using the frequency coefficients;
a linear prediction coefficient quantizer configured to quantize the linear prediction coefficients and generate linear prediction coefficient indices;
a linear prediction analysis filter configured to calculate residual coefficients for the frequency coefficients by using linear prediction coefficients quantized from the linear prediction coefficient indices; and
a multiplexer configured to calculate a bit stream by multiplexing the linear prediction coefficient indices and the sub-band quantization indices.

11. A method of a codec apparatus for coding a signal in a communication system, the method comprising:
transforming a speech and audio signal in a time domain into a speech and audio signal in a frequency domain and calculating frequency coefficients of the speech and audio signal;
splitting the frequency coefficients by a plurality of sub-bands and calculating sub-band coefficients of the respective sub-bands from the frequency coefficients; and
quantizing the sub-band coefficients depending on a characteristic of the plurality of sub-bands and calculating sub-band quantization indices by quantizing the sub-band coefficients.

12. The method of claim 11, wherein the calculating of sub-band quantization indices comprises:
a step of calculating a quantization mode value by taking the characteristic of the plurality of sub-bands into consideration;
a first quantization step of quantizing the sub-band coefficients based on the quantization mode value and generating gain-shape indices as the sub-band quantization indices; and
a second quantization step of quantizing the sub-band coefficients based on the quantization mode value and quantizing track-pulse indices as the sub-band quantization indices.

13. The method of claim 12, wherein the step of calculating a quantization mode value by taking the characteristic of the plurality of sub-bands into consideration comprises calculating the quantization mode value by using a Spectral Flatness Measure (SFM) or kurtosis representing a spectral flatness scale of the sub-band coefficients.

14. The method of claim 13, wherein:
when the spectral flatness scale of the sub-band coefficients is larger than a predefined threshold, the first quantizer calculates the sub-band quantization indices; and
when the spectral flatness scale of the sub-band coefficients is smaller than the predefined threshold, the second quantizer calculates the sub-band quantization indices.

15. The method of claim 12, wherein the step of calculating a quantization mode value by taking the characteristic of the plurality of sub-bands into consideration comprises calculating the quantization mode value by using two sets of the quantized sub-band coefficients decoded from the gain-shape indices and the track-pulse indices, respectively.

16. The method of claim 15, wherein the step of calculating a quantization mode value by taking the characteristic of the plurality of sub-bands into consideration comprises calculating the quantization mode value by computing each Segmental Signal-to-Noise Ratio (SSNR) between unquantized sub-band coefficients and respective quantized sub-band coefficients.

17. The method of claim 16, wherein the step of calculating a quantization mode value by taking the characteristic of the plurality of sub-bands into consideration comprises calculating the quantization mode value to calculate the sub-band quantization indices with minimum quantization error or maximum SSNR.

18. The method of claim 12, wherein the first quantization step comprises:
calculating a gain of the sub-band coefficients;
quantizing the gain of the sub-band coefficients and generating gain indices corresponding to the quantized gain;
normalizing the sub-band coefficients using a gain quantized by restoring the gain indices and generating shape coefficients; and
quantizing the shape coefficients and generating shape indices corresponding to the quantized shape coefficients.

19. The method of claim 12, wherein the second quantization step comprises:
arranging the sub-band coefficients based on a track structure, searching for a track-pulse of the sub-band coefficients, and searching for pulses per each track of the sub-band coefficients;
encoding position information on a position of the pulses searched in each track of the plurality of sub-bands and generating position indices;
quantizing amplitude components on a amplitude of the pulses searched in each track of the plurality of sub-bands and generating amplitude indices; and
quantizing sign components of the pulses searched in each track of the plurality of sub-bands and generating sign indices.

20. The method of claim 11, further comprising:
calculating linear prediction coefficients by using the frequency coefficients;
quantizing the linear prediction coefficients and generating linear prediction coefficient indices;
calculating residual coefficients for the frequency coefficients by using linear prediction coefficients quantized from the linear prediction coefficient indices; and
calculating a bit stream by multiplexing the linear prediction coefficient indices and the sub-band quantization indices.
